(19) United States
(12) Patent Application Publication
(10) Pub. No.: US 2008/0253859 A1
(43) Pub. Date: Oct. 16, 2008

(54) CAGE NUT FASTENING SYSTEM

(76) Inventors: LAWRENCE W. JOHNSON, Taylor, MI (US); MANUEL J. MARTINS, Artesia, CA (US); HECTOR A. MOLINA, Monte Bello, CA (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/968,727

(22) Filed: Jan. 3, 2008

Related U.S. Application Data
(60) Provisional application No. 60/923,045, filed on Apr. 12, 2007.

(51) Int. Cl. F16B 37/04

(52) U.S. Cl. 411/103

(57) ABSTRACT

A cage-nut assembly is configured to securely clamp to at least one panel. The assembly includes a cage including an annular base integrally connected to beams having flat tabs extending from ends thereof. A nut chamber is defined between the annular base and the beams. A nut is positioned within the nut chamber, wherein at least one of the flat tabs prevents the nut from ejecting from the cage. The panel is configured to be clamped between the flat tabs and a portion of the nut.

### RELATED APPLICATIONS

This application relates to and claims priority benefits from U.S. Provisional Patent Application No. 60/923,045 entitled “Cage Nut Fastening Assembly,” filed Apr. 12, 2007, which is hereby incorporated by reference in its entirety.

### FIELD OF THE INVENTION

Embodiments of the present invention generally relate to a fastening assembly, and more particularly to a two-piece threaded cage-nut fastening system.

### BACKGROUND OF THE INVENTION

Various vehicle assemblies include tubes, such as hydro-form tubes, that are used for structural support and for connecting various components together. Typical hydro-form tubes are inaccessible to internal place threaded fasteners due to the closed nature of the tubes. Thus, in order to secure one tube to another component, such as a vehicle panel or another tube, the base material of the tube, which may include a single threaded form to accept a threaded fastener, is used.

FIG. 1 illustrates an isometric view of a conventional tube or frame 10 that includes a weld nut 12 secured within an interior chamber 14 of the tube 10. The tube 10 includes a base 16 integrally connected to upstanding lateral walls 18, which are, in turn, integrally connected to an upper wall 20. The interior chamber 14 is defined by the base 16, lateral walls 18 and the upper wall 20. The weld nut 12 is secured to the base 16. A hole 22 is formed through the upper wall 20 opposite the eventual location of the weld nut 12. The hole 22 provides access to the portion of the base 16 where the weld nut 12 is eventually secured. As such, the weld nut 12 is positioned on the base 16 through the hole 22. Once the weld nut 12 is positioned on the base 16, it is secured thereto in a known manner. The weld nut 12 includes a threaded channel 23, which is configured to receive and threadably retain a reciprocal fastener, such as a threaded screw.

FIG. 2 illustrates an isometric interior view of the conventional tube or frame 10 having a pucker fastener 24 secured within the interior chamber 16, instead of the threaded weld nut 12 that is shown in FIG. 1. The pucker fastener 24 includes a fastener passage 26 that is not threaded. Instead, the fastener passage 26 has a slight funnel configuration. A self taping screw or other such fastener is used with such a configuration.

Conventional fastening joints, such as are shown in FIGS. 1 and 2, do not, however, provide high clamp load retaining forces. This is due to their use of a single threaded or pucker style fastener within the closed-box or cylindrical nature of the frames or tubes themselves. Because the fasteners are within the tubes or frames themselves, care is taken to ensure that the tubes are not damaged during a fastening process. If too much fastening force is applied, the lateral walls and top surface may bend, warp or even break due to the fact that a component being secured to the tube or frame is ultimately moving toward the base of the tube or frame.

### SUMMARY OF THE INVENTION

Embodiments of the present invention provide a fastening assembly that provides increased clamping and retaining force, as compared to conventional fastening joints used with tubes or frames.

Certain embodiments of the present invention provide a cage-nut assembly configured to securely clamp to at least one panel. The cage-nut assembly includes a cage and a nut.

The cage includes an annular base integrally connected to beams having flat tabs extending from ends thereof. Each of the flat tabs may include a radially extending beam. A nut chamber is defined between the annular base and the beams.

The nut is positioned within the nut chamber. At least one of the flat tabs prevents the nut from ejecting from the cage. The panel is configured to be clamped between the flat tabs and a portion of the nut. The flat tabs are flush with the at least one panel.

The nut may include at least one lateral support member extending from a main wall or body. The lateral support member may be curved into an inverted U-shape. For example, two lateral support members may extend from the main wall or body. At least two of the beams may be separated by a gap, wherein the at least one lateral support member is slidably secured within said gap. The flat tabs may prevent the lateral support members from ejecting from the gap.

Certain embodiments of the present invention provide a system for securely clamping first and second panels together. The system includes a cage, a nut and a fastener.

The cage may include an annular base integrally connected to beams having flat tabs extending from ends thereof. A nut chamber is defined between the annular base and the beams.

The nut is positioned within the nut chamber and includes a fastener through-hole. The flat tabs prevent the nut from ejecting from the cage.

The fastener includes an engagement head integrally connected to a shaft having a distal tip. The shaft is positioned within the fastener through-hole.

The fastener is securely tightened to clamp the first and second panels together. The first panel is clamped between the flat tabs and a portion of the nut when the fastener is securely tightened. The second panel is clamped between the flat tabs and the engagement head when the fastener is securely tightened.

Certain embodiments of the present invention provide a cage-nut assembly configured to securely clamp a first and second panel together. The cage nut includes a cage and a nut.

The cage may include a cage including an annular base integrally connected to beams having flat tabs extending from ends thereof. Two gaps may be formed from the base and extend to heights of the beams. A nut chamber is defined between the annular base and the beams.

A nut is positioned within the nut chamber. The nut may include a cylindrical main body having a fastener through-hole formed therethrough. The nut may also include first and second support members extending outwardly from the main body. Each of the first and second support members may be slidably secured within one of the gaps. At least one of the flat tabs prevents the nut from ejecting from the cage. One or both of the panels is configured to be clamped between the flat tabs and the first and second support members.

### BRIEF DESCRIPTION OF SEVERAL VIEWS OF THE DRAWINGS

FIG. 1 illustrates an isometric view of a conventional tube that includes a weld nut secured within an interior chamber of the tube.

FIG. 2 illustrates an isometric interior view of a conventional tube including a fastener secured within an interior chamber.

FIG. 3 illustrates an isometric exploded view of a cage-nut fastener assembly according to an embodiment of the present invention.

FIG. 4 illustrates an isometric top view of a cage-nut fastener assembly according to an embodiment of the present invention.

FIG. 5 illustrates an isometric top view of a cage-nut fastener assembly positioned over a panel according to an embodiment of the present invention.

FIG. 6 illustrates a side view of a cage-nut fastener assembly passing into a panel according to an embodiment of the present invention.

FIG. 7 illustrates an isometric top view of a cage-nut fastener assembly supported on a panel according to an embodiment of the present invention.

FIG. 8 illustrates a side view of a cage-nut fastener assembly supported on a panel according to an embodiment of the present invention.

FIG. 9 illustrates an isometric view of a fastener securing into a cage-nut assembly according to an embodiment of the present invention.

FIG. 10 illustrates a side view of a fastener fully securing a cage-nut assembly to a panel according to an embodiment of the present invention.

FIG. 11 illustrates an isometric cross-sectional view of a cage-nut system securing a first panel to a second panel according to an embodiment of the present invention.

FIG. 12 illustrates an isometric cross-sectional view of a cage-nut system secured to a first panel that is positioned over a second panel according to an embodiment of the present invention.

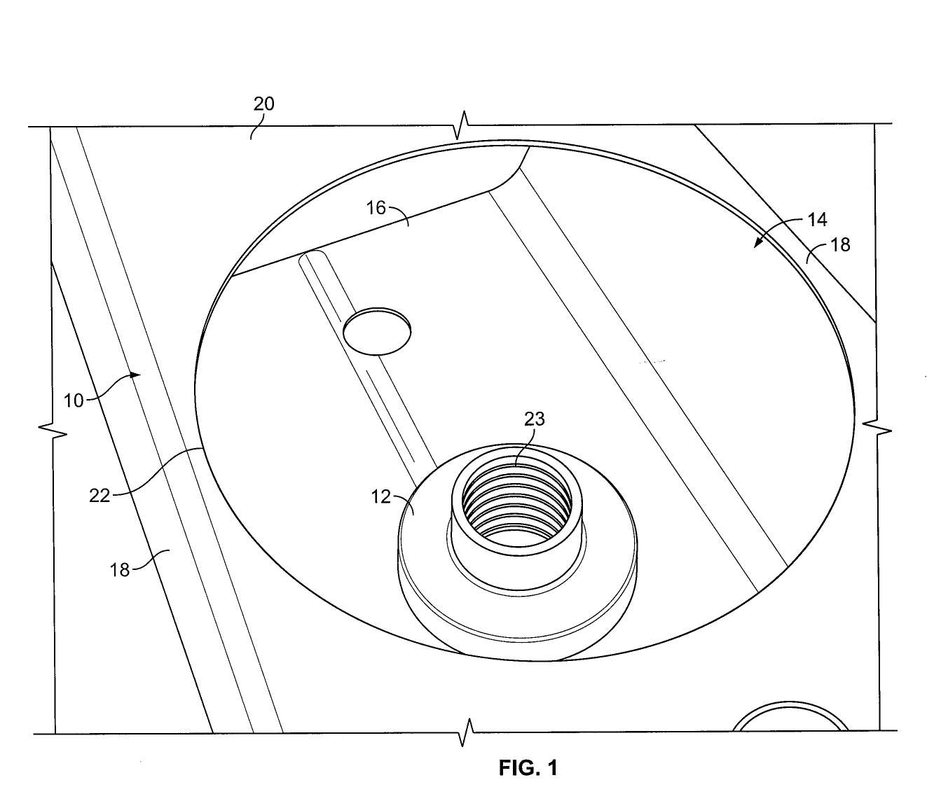

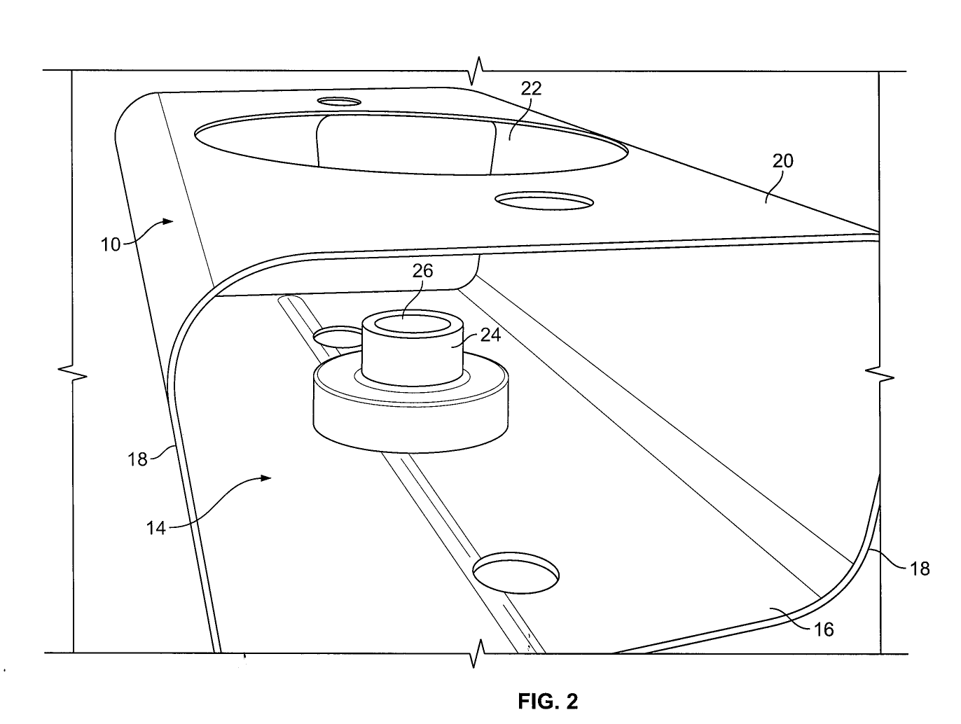

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

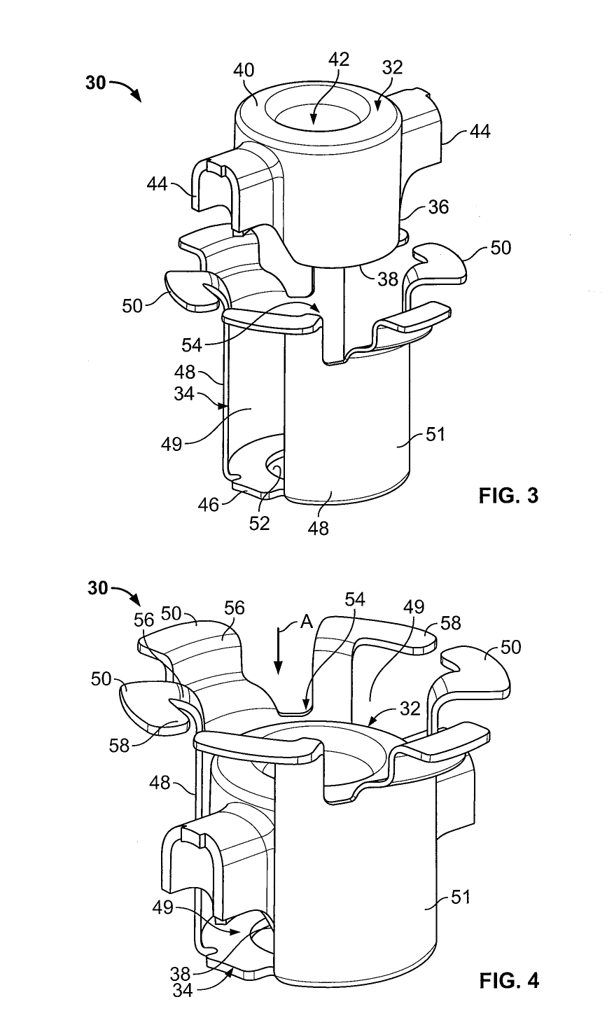

FIG. 3 illustrates an isometric exploded view of a cage-nut fastener assembly 30 according to an embodiment of the present invention. The fastener assembly 30 may be used with respect to hydro-form tube applications. In general, the fastener assembly is used to secure and fasten objects to sheet metal type components.

The fastener assembly 30 includes a nut 32 and a cage 34. Both the nut 32 and the cage 34 may be deep draw stampings. The nut 32 may be formed through a press-tap-press process. For example, the nut 32 may be extruded from flat stock. Rolled inline threads may then be formed on or within the nut 32.

The nut 32 includes a generally cylindrical main body or wall 36 that connects lower edges 38 to a rounded upper surface 40. A fastener through-hole 42 is formed through the rounded upper surface 40 and extends through at least a portion of the length of the main wall 36. The fastener through-hole 42 may be threaded or unthreaded, depending on the type of fastener to be used.

Lateral support wings, stubs, tubes, posts, or other such members 44 extend from the main wall 36 proximate, but are offset below, the upper surface 40. The lateral support members 44 may be curved, semi-tubular structures. As shown in FIG. 3, a profile of each lateral support member 44 may be in the shape of an inverted U. The inverted U shape increases the strength of the lateral support members 44, thereby allowing them to support increased loads. However, various other shapes may be used.

While the nut 32 includes two lateral support members 44 spaced 180° from one another, the nut 32 may include more or less lateral support members 44 than those shown. However, the 180° spacing ensures a uniform clamping force with respect to a panel that is secured between the lateral support members 44 and the tabs 50. In general, equidistant spacing between support members 44 provides even distribution of clamping force. Thus, if four lateral support members 44 are used, adjacent support members 44 may be spaced 90° from one another to ensure an even clamping force with respect to a panel.

The cage 34 includes an annular base 46 integrally connected to a plurality of upstanding beams, legs or wall portions 48. A gap 49 is formed between two adjacent beams 48. As shown, the cage 34 includes two gaps 49. The gaps 49 are configured to allow the lateral support members 44 to pass between the beams 48. While the cage 34 is shown with two gaps 49 and support walls 51 (that may include multiple beams 48 extending upwardly therefrom) extending upwardly from the base 46, the cage 34 may, alternatively, include additional gaps 49 between adjacent beams 48 (as opposed to the support walls 51).

Flattened tabs 50 are integrally connected to ends of the beams 48 that are distally located from the base 46. The planes of the flattened tabs 50 are generally coplanar and parallel to the plane of the base 46. Further, the beams 48 are generally perpendicular to the tabs 50 and the base 46. A hole 52 may be formed through a center of the base 46. Further, a nut chamber 54 is defined between the base 46 and the beams 48.

FIG. 4 illustrates an isometric top view of the cage-nut fastener assembly 30. During a manufacturing process, the nut 32 is positioned on or within a piece of material that is to become the cage 34. In particular, the cage 34 may initially be in a flat blank state and then folded, such as at a 60° angle. The nut 32 may then be inserted into the interior cavity of the folded cage 34. After the nut 32 is inserted into the cage 34, the remainder of the cage 34 (e.g., the beams 48) is folded around the nut 32. The lower edges 38 of the nut 32 are supported by the base 46. Thus, a customer may receive a pre-assembled fastener assembly 30 in which the nut 32 is securely retained within the cage 34. In this configuration, portions of the tabs 50 prevent the lateral support members 44 from ejecting out of the gaps 49.

Optionally, in order to assemble the fastener assembly 30, the nut 32 may be positioned over the cage 34 such that the lateral support members 44 are aligned with the gaps 49. The nut 32 may then be dropped, urged, or otherwise moved into the nut chamber 54 in the direction of arrow A.

As shown in FIG. 4, the flattened tabs 50 integrally connect to the ends 56 of the upstanding beams 48. The tabs 50 may also include extending portions, such as beams or tabs, 58 that radially extend from the ends 56 forming a semi-circumferential ring. The extending portions 58 provide additional supporting surface area. The extending portions 58 also block movement of the lateral support members 44 (and therefore the nut 32) out of the cage 34. That is, as shown in FIG. 4, the extending portions 58 provide a barrier that prevents the lateral support member members 44 from ejecting out of the cage 34.

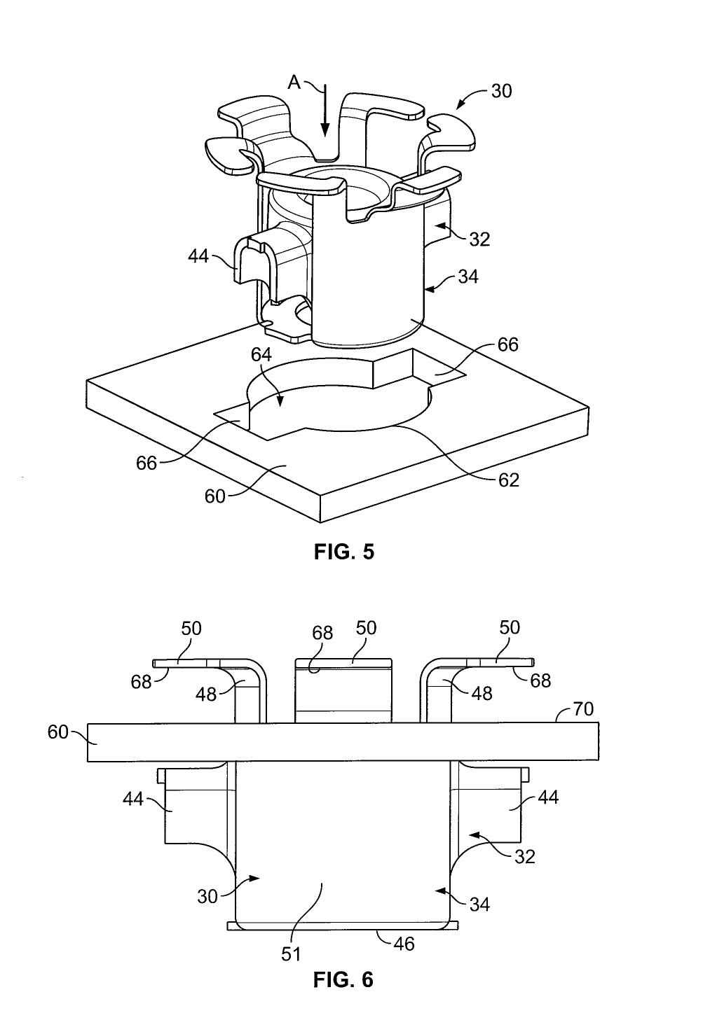

FIG. 5 illustrates an isometric top view of the cage-nut fastener assembly 30 positioned over a panel 60 according to an embodiment of the present invention. The panel 60 may be a wall of a tube or frame. The panel 60 includes a key-hole 62 having a generally circular passage 64 and lateral slots 66. The key-hole 62 is shaped similar to the axial cross-section of the nut 32.

In order to position the fastener assembly 30 within the key-hole 52, the lateral support members 44 are aligned with the slots 66. The fastener assembly 30 is then dropped, urged, or otherwise moved into the key-hole 52 in the direction of arrow A.

FIG. 6 illustrates a side view of the cage-nut fastener assembly 30 passing into the panel 60. In this view, the lateral support members 44 have passed through the slots 66 (shown in FIG. 5), while the base 46 and support walls 51 of the cage have passed through the passage 64. Once the lateral support members 44 have passed through the slots 66, the fastener assembly 30 may be rotated 90° so that the lateral support members 44 are no longer aligned with the slots 66. As such, the fastener assembly 30 is prevented from ejecting from the panel 60. The rotation also ensures that the tabs 50 will be flush with the upper surface 70 of the panel 60.

Additionally, an outer perimeter of the tabs 50 is larger than an outer perimeter of the key-hole 62. As such, the cage 34 is prevented from fully passing through the key-hole 62. Instead, lower surfaces 68 of the tabs 50 are configured to abut an upper surface 70 of the panel 60.

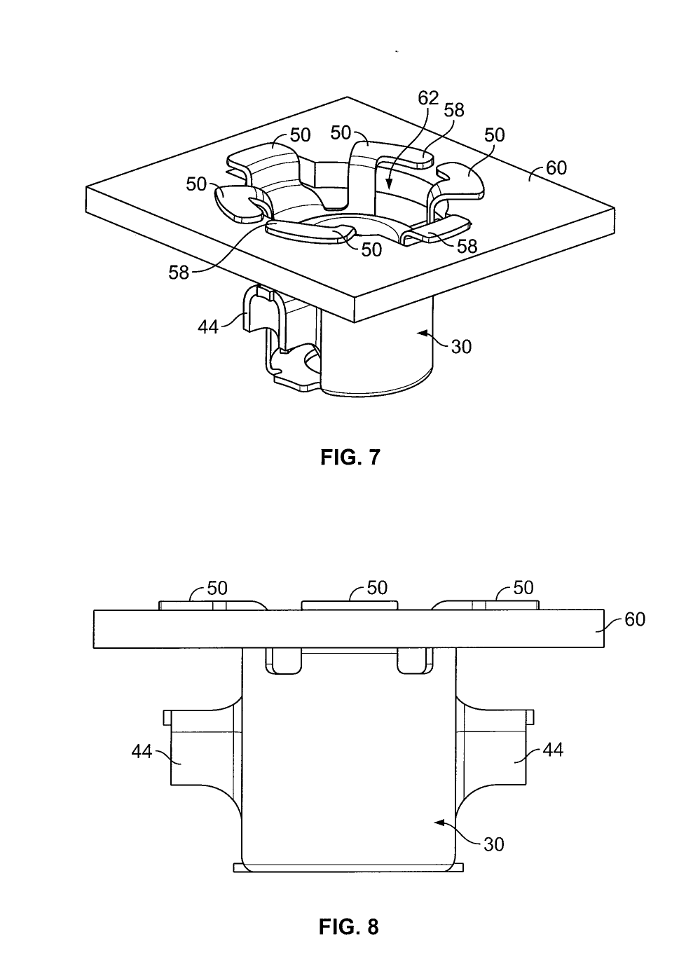

FIGS. 7 and 8 illustrate an isometric top view and a side view, respectively, of the cage-nut fastener assembly 30 supported on the panel 60. As shown in FIGS. 7 and 8, the tabs 50 abut the panel 60, ensuring that the fastener assembly 30 does not slip through the key-hole 62. As noted above, the radially-extending portions 58 of the tabs 50 provide additional surface area for supporting the fastener assembly 30 with respect to the panel 60. That is, the extending portions 58 give the tabs 50 increased supporting strength and distribute forces more evenly over the surface of the panel 60.

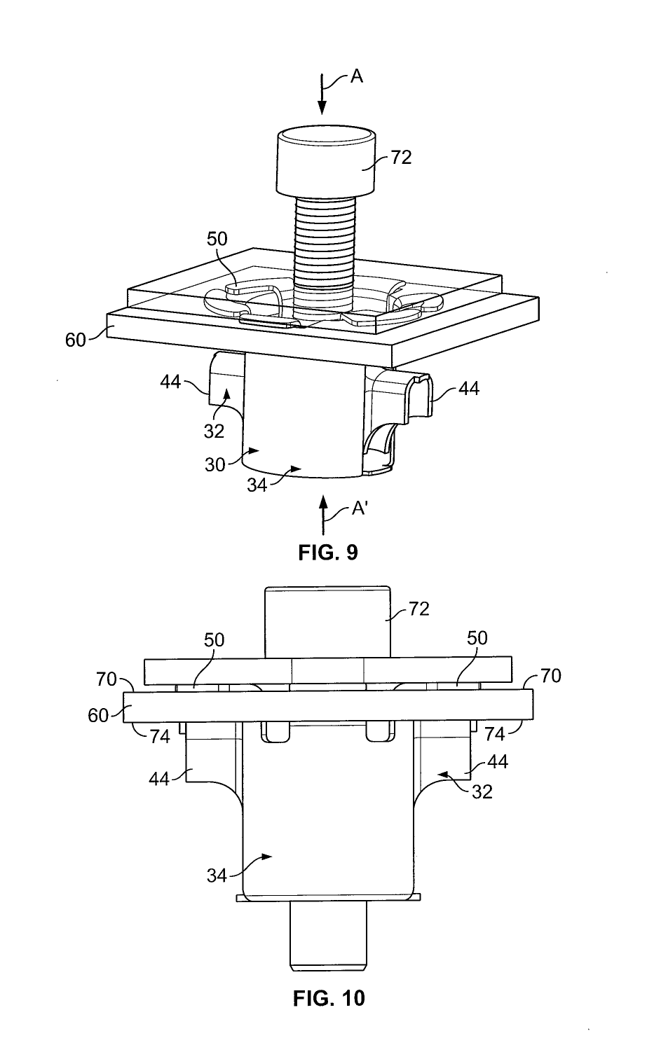

FIG. 9 illustrates an isometric view of a fastener 72 securing into the cage-nut assembly 30 according to an embodiment of the present invention. Referring to FIGS. 3-9, an a distal end of a shaft of the fastener 72 is positioned within the fastener through hole 42 of the nut 32. The fastener 72 may be a threaded screw or bolt, or may be unthreaded, depending on the nature of the through-hole 42. As the fastener 72 is tightened, the fastener 72 moves into the nut 32 in the direction of arrow A, while the nut 32 begins to move toward the panel 60 in the direction of arrow A′.

FIG. 10 illustrates a side view of the fastener 72 fully securing the cage-nut assembly 30 to the panel 60. When the fastener 72 is fully tightened, the lateral support members 44 abut into a lower surface 74 of the panel 60, while the tabs 50 abut into the upper surface 70 of the panel 60. The panel 60 is thereby securely clamped, or compressively sandwiched, between the lateral support members 44 of the nut 32 and the tabs 50 of the cage 34. Thus, the cage-nut assembly 30 is capable of providing a higher clamping and retaining force, as compared to conventional tube fasteners.

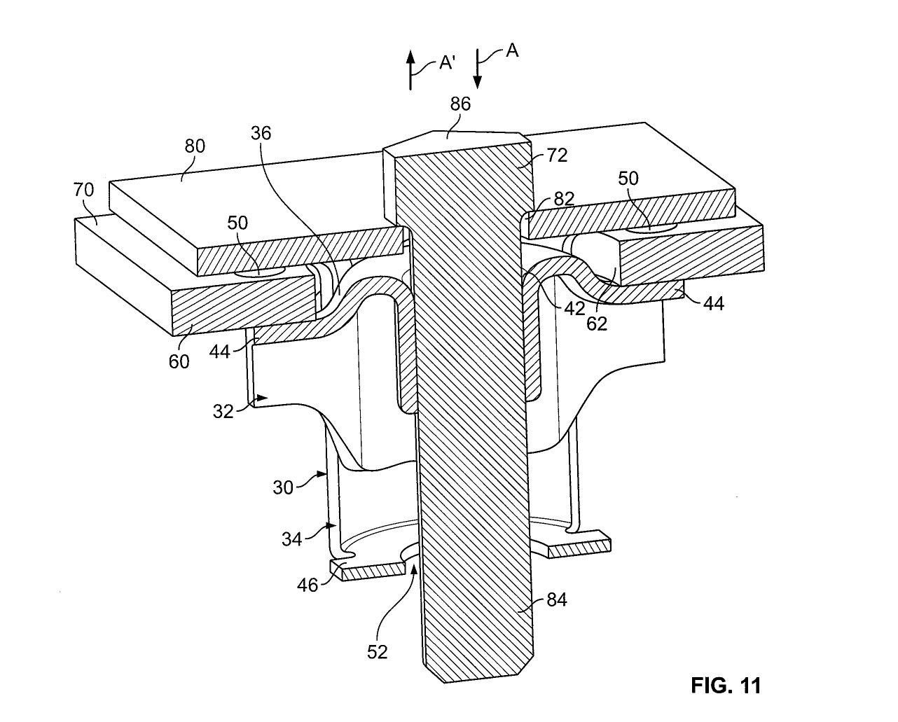

FIG. 11 illustrates an isometric cross-sectional view of a cage-nut system 78 securing the panel 60 to another panel 80 according to an embodiment of the present invention. The system 78 includes the cage-nut fastener assembly 30 and the fastener 72. The panel 80 overlays the panel 60 and includes a hole 82 that is aligned over the key-hole 62. Once the panels 60 and 80 are aligned, the distal end 84 of the fastener 72 is passed through the hole 82 and the key-hole 60 and into the fastener through-hole 42 of the nut 32. The engagement head 86 of the fastener 72 is then torqued to tighten the fastener 72 within the nut 32. As the fastener 72 is tightened, the nut 32 moves toward the panel 60. At the same time, the panel 80 is compressed into the tabs 50 and the panel 60. When the fastener 72 is fully tightened, the lateral support members 44 are compressed into the lower surface 74 of the panel 60, while the tabs 50 are compressed into the upper surface 70 of the panel 60. Further, the panel 80 is securely clamped between the engagement head 86 and the tabs 50 and the upper surface 70 of the panel 60. As shown in FIG. 11, the distal end 84 of the fastener 72 may pass through the hole 52 formed through the base 46 of the cage 34. Thus, the cage-nut system 78 may be used to securely clamp and retain the panels 60 and 80 together.

As shown in FIG. 11, the cylindrical shape of the cage 34 and the reciprocal shape of the cylindrical main wall 36 within the cage 34 prevent the nut 32 from flipping or rotating when the fastener 72 is tightened. Additionally, the lateral support members 44 are offset from the top of the nut 34 to ensure that the lateral support arms 44 abut into the panel 60 when the fastener 72 is securely tightened. Further, the nut 32 is relatively tall and easily engages the fastener 72. Because the nut 32 is supported relatively high above the base 46 of the cage 34 and is axially secured within the cage 34, the nut 32 is able to easily slide within the cage in the direction of arrows A and A′, thereby allowing easier clamping and alignment with respect to the panels 60 and 80.

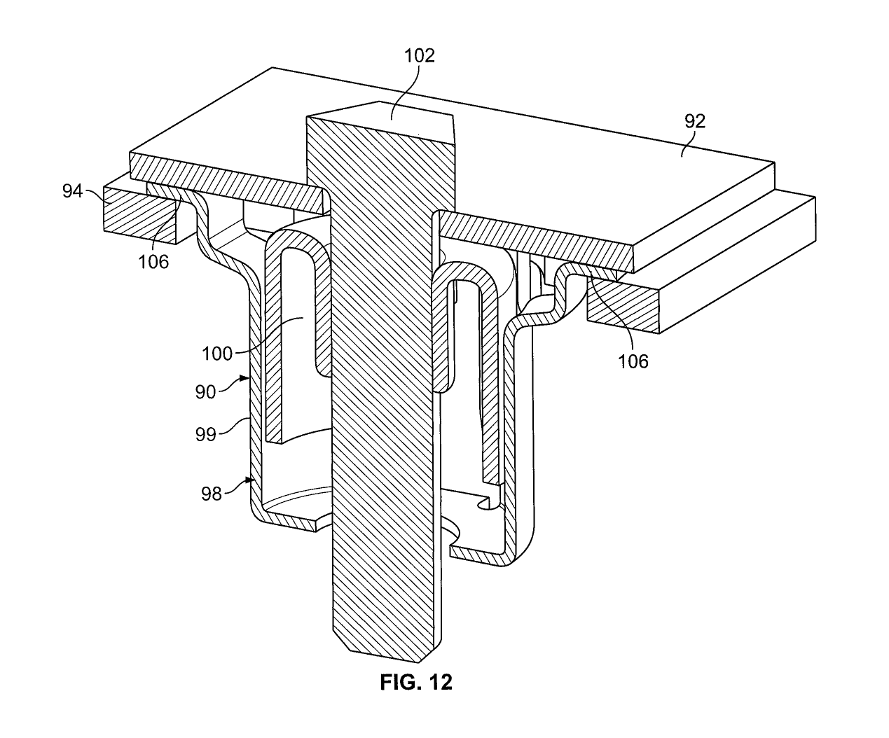

FIG. 12 illustrates an isometric cross-sectional view of a cage-nut system 90 securing to a panel 92 that is positioned over another panel 94 according to an embodiment of the present invention. The system 90 includes a nut 96 secured within a cage 98. The nut 96 includes a general cylindrical body that includes downwardly curved walls 100 that are bent, crimped, or the like and fit within the cage 98. As such, the nut 96 does not include lateral support members that extend outwardly past upstanding beams 99 of the cage 98. The panel 92 is compressively sandwiched between an engagement head 102 of a fastener 104 and tabs 106 of the cage 98.

Optionally, the cage nut system 90 shown in FIG. 12 may be the cage nut system 78 shown in FIG. 11, but through a cross-section that is rotated 90° from that shown in FIG. 11.

Embodiments of the present invention provide a fastening assembly that does not need to be secured within a tube or frame. Instead, embodiments of the present invention provide a fastening assembly that may securely clamp to outer surfaces of portions of tubes or frames. Thus, the tubes or frames are less susceptible to bending or warping as compared to tubes or frames that use fastener systems within the tubes themselves.

While various spatial terms, such as upper, lower, mid, lateral, horizontal, vertical, and the like may used to describe portions of the embodiments discussed above, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A cage-nut assembly configured to securely clamp to at least one panel, the cage-nut assembly comprising:
a cage comprising an annular base integrally connected to beams having flat tabs extending from ends thereof, wherein a nut chamber is defined between said annular base and said beams; and
a nut positioned within said nut chamber, wherein at least one of said flat tabs prevents said nut from ejecting from said cage,
wherein the at least one panel is configured to be clamped between said flat tabs and a portion of said nut.

2. The cage-nut assembly of claim 1, wherein said flat tabs are flush with the at least one panel.

3. The cage-nut assembly of claim 1, wherein said nut comprises at least one lateral support member extending from a main wall, and wherein at least two of said beams are separated by a gap, wherein said at least one lateral support member is slidably secured within said gap.

4. The cage-nut assembly of claim 3, wherein said at least one lateral support member comprises two lateral support members.

5. The cage-nut assembly of claim 3, wherein at least one of said flat tabs prevents said at least one lateral support member from ejecting from said gap.

6. The cage-nut assembly of claim 3, wherein said at least one lateral support member is curved into an inverted U-shape.

7. The cage-nut assembly of claim 1, wherein at least one of said flat tabs comprises a radially-extending beam.

8. A system for securely clamping first and second panels together, the system comprising:
a cage comprising an annular base integrally connected to beams having flat tabs extending from ends thereof, wherein a nut chamber is defined between said annular base and said beams;
a nut positioned within said nut chamber, said nut comprising a fastener through-hole, wherein at least one of said flat tabs prevents said nut from ejecting from said cage;
a fastener comprising an engagement head integrally connected to a shaft having a distal tip, said shaft being positioned within said fastener through-hole,
wherein said fastener is securely tightened to clamp the first and second panels together, the first panel being configured to be clamped between said flat tabs and a portion of said nut when said fastener is securely tightened, and wherein the second panel is configured to be clamped between said flat tabs and said engagement head when said fastener is securely tightened.

9. The system of claim 8, wherein said flat tabs are flush with the first and second panels when said fastener is securely tightened.

10. The system of claim 8, wherein said nut comprises at least one lateral support member extending from a main wall, and wherein at least two of said beams are separated by a gap, wherein said at least one lateral support member is slidably secured within said gap.

11. The cage-nut assembly of claim 10, wherein said at least one lateral support member comprises two lateral support members.

12. The cage-nut assembly of claim 10, wherein at least one of said flat tabs prevents said at least one lateral support member from ejecting from said gap.

13. The cage-nut assembly of claim 10, wherein said at least one lateral support member is curved into an inverted U-shape.

14. The cage-nut assembly of claim 8, wherein at least one of said flat tabs comprises a radially-extending beam.

15. A cage-nut assembly configured to securely clamp a first and second panel together, the cage-nut assembly comprising:
a cage comprising an annular base integrally connected to beams having flat tabs extending from ends thereof, wherein two gaps are formed from said base and extend to heights of said beams, wherein a nut chamber is defined between said annular base and said beams; and
a nut positioned within said nut chamber, said nut comprising a (i) cylindrical main body having a fastener through-hole formed therethrough, and (ii) first and second support members extending outwardly from said main body, each of said first and second support members being slidably secured within one of said gaps, wherein at least one of said flat tabs prevents said nut from ejecting from said cage,
wherein at least one of the first and second panels is configured to be clamped between said flat tabs and said first and second support members.

16. The cage-nut assembly of claim 15, wherein said flat tabs are flush with the at least one panel.

17. The cage-nut assembly of claim 15, wherein at least one of said flat tabs prevents said at least one support member from ejecting from said gap.

18. The cage-nut assembly of claim 15, wherein the first support member is spaced 180° from the second support member.

19. The cage-nut assembly of claim 15, wherein each of said first and second support members is curved into an inverted U-shape.

20. The cage-nut assembly of claim 15, wherein at least one of said flat tabs comprises a radially-extending beam.
